(19) United States
(12) Patent Application Publication
(10) Pub. No.: US 2006/0282177 A1
(43) Pub. Date: Dec. 14, 2006

(54) System and method of applying interior point method for online model predictive control of gas turbine engines

(75) Inventors: James W. Fuller, Amston, CT (US); Indraneel Das, Manchester, CT (US); Florian Potra, Reisterstown, MD (US); Jun Ji, Marietta, GA (US)

Correspondence Address: CARLSON, GASKEY & OLDS, P.C., 400 WEST MAPLE ROAD, SUITE 350, BIRMINGHAM, MI, 48009, US

(73) Assignee: United Technologies Corporation

(21) Appl. No.: 11/150,703

(22) Filed: Jun. 10, 2005

(51) Int. Cl. G05B 13/02

(52) U.S. Cl. 700/28; 700/29

(57) ABSTRACT

A Model Predictive Control System, particularly useful in controlling gas turbine engines, formulates a problem of controlling the engine to achieve a desired dynamic response as a solution to a quadratic programming problem. The Model Predictive Control System also includes a quadratic programming problem solver solving the quadratic programming problem in real time using an interior point algorithm that searches for an optimal solution.

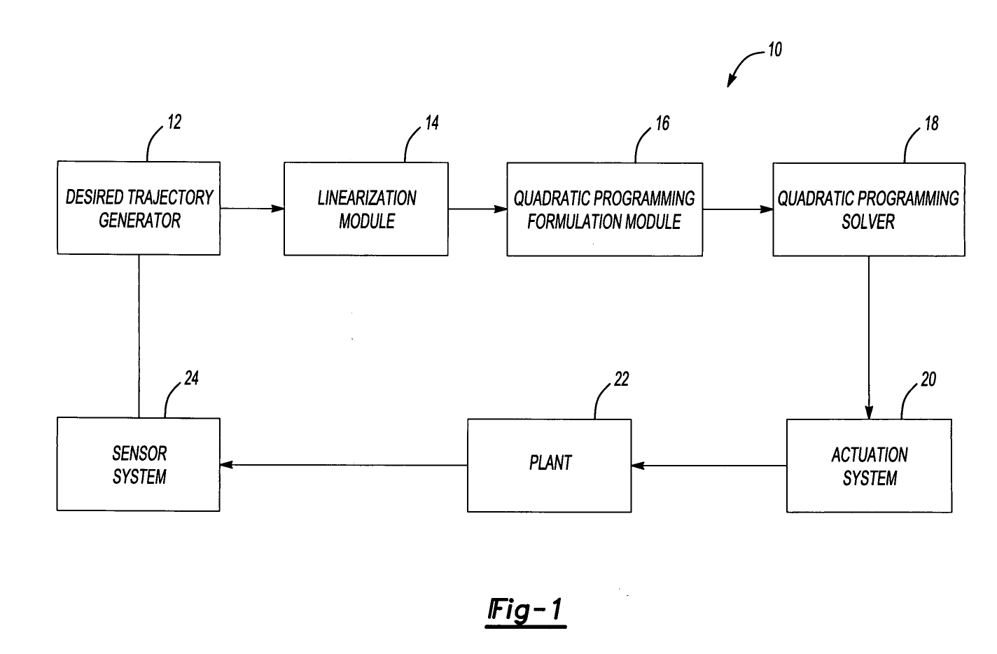

This invention was conceived in performance of work under U.S. Government Contract N00421-01-2-0131.

### BACKGROUND OF THE INVENTION

Model Predictive Control refers to the procedure of determining optimal operating parameters of a dynamic process based on a model of the ‘plant’, or the dynamical system. This plant model can be a physics-based model of any physical system, but for the purposes of this invention, gas turbine engines, such as the ones found in commercial jets and power plants are the focus. It is of interest to engineers to operate such an engine optimally, i.e. meet or exceed certain goals during operation, while honoring physical constraints on the engine. To this end, it is common to solve a constrained optimization problem during the operation of the engine, and update the parameters of the optimization problem as the system evolves in time or as the forecast of the future requirements change, and re-solve the problem.

While interior point method have been widely used to solve optimization problems in finance and operations research, the applications did not demand solutions in real-time. While there may be process control applications to which interior point methods have been applied, the demands of online computation are far more relaxed, requiring a reasonably accurate solution in minutes, often hours. However, for gas turbine engines, no more than a fraction of a second is allowed to obtain a solution.

### SUMMARY OF INVENTION

The present invention provides a Model Predictive Control system including a desired trajectory generator for creating a desired trajectory and a linearization module deriving a linearized model about the desired trajectory. A quadratic programming module, in each of a plurality of time steps, formulates a problem of achieving the desired trajectory for a multiple timestep window as a solution to a quadratic programming problem.

A quadratic programming solver solves the optimization problem established by the quadratic programming module to generate a profile of optimal controls. The quadratic programming solver solving the quadratic programming problem in real time in each time step using an interior point algorithm that searches for an optimal solution.

### BRIEF DESCRIPTION OF THE DRAWINGS

Other advantages of the present invention will be readily appreciated as the same becomes better understood by reference to the following detailed description when considered in connection with the accompanying drawings wherein:

The FIGURE illustrates a control system that uses the Model Predictive Control method of the present invention.

### DESCRIPTION OF A PREFERRED EMBODIMENT

The FIGURE is a generic model of a control system 10 using Model Predictive Control and of a type that would benefit from the present invention. The control system 10 includes a desired trajectory generator 12 which creates a desired profile of the outputs of the system 10. A linearization module 14 derives a linearized model about the desired trajectory from the desired trajectory generator 12. A quadratic Programming formulation module 16 forms a quadratic program to determine a control profile for best attaining the desired trajectory while respecting any constraints. The Quadratic Programming Solver 18 solves the optimization problem established by the formulation module 16 to generate a profile of the optimal controls. The Quadratic Programming Solver 18 is the focus of this invention. The profile of the optimal controls is sent to an actuation system 20, which acts on the plant 22 of the system 10. The sensor system 24 provides feedback from the plant 22 to the desired trajectory generator 12.

The Generic Problem

Consider a nonlinear dynamical system with control variables u, state variables ξ, and responses (or outputs) χ, that are related as

$$\begin{matrix}\frac{ⅆ ξ}{ⅆ t} = ϕ ( ξ , u ) \\ χ = h ( ξ , u ) .\end{matrix}$$

A discrete time version of the above with uniform time intervals can be written as
ξᵢt+1=ξₜφ(ξₜ,uₜ)Δt
χₜ=h(ξₜ,uₜ)t=1, 2, . . . , N.

The nonlinear functions φ and h are commonly linerized about base points which are steady state points, i.e., ones at which ξ vanishes. Given such a steady state base point ξₛ, uₛ, i.e., one where φ(ξₛ, uₛ)=0), the discrete time system can be linearized and put in the following form

Control engineers commonly express the above system as
ξₜ₊₁=xbₜ+Aₜξₜ+Bₜuₜ (1)
χₜ=ybₜ+Cₜξₜ+Dₜuₜ,t=1, 2, . . . , N. (2)
where
Aₜ=I+φ_{ξ}(ξₛ,uₛ)Δt
Bᵢ=φᵤ(ξₛ,uₛ)Δt
Cₜ=h_{ξ}(ξₛ,uₛ)Δt
Dₜ=hᵤ(ξₛ,uₛ)Δt
xbₜ=−(φ_{ξ}(ξₛ,uₛ)ξₛ+φᵤ(ξₛ,uₛ)uₛ)Δt
ybₜ=h(ξₛuₛ)−(h_{ξ}(ξₛ,uₛ)ξₛ+hᵤ(ξₛ,uₛ)uₛ)Δt

The time dependence of the above parameters that define the linearized discrete time system is tacitly hidden in (ξₛ, uₛ) the point about which the linearization is performed, which is chosen afresh for each time point. Note that in this quasi-Linear parameter (q-LPV) varying model, this point of linearization can be a convex combination of several steady state points. The q-LPV model while no substitute for a true nonlinear model, is often sufficient for the level of accuracy required in a feedback control framework. If a true nonlinear model were to become available, the techniques in this paper are just as applicable to the quadratic programs obtained from a true linearization.

Objective Given the above description of the system, the aim is to optimally control the system over a particular time window. The degree of success in doing so is measured by how closely the variables of the system track certain reference trajectories. If Tₜ^{y}, Tₜ^{x}, Tₜ^{u} represent reference trajectories for χₜ, ξₜ, uₜ, the desired objective can be express as

$${min}_{ξ , χ , u} {\sum }_{t = 1}^{N} ‖ {χ}_{t} - {T}_{t}^{χ} ‖ {w}_{x} + {\sum }_{t = 1}^{N} ‖ {ξ}_{t} - {T}_{t}^{ξ} ‖ {w}_{ξ} + {\sum }_{t = 1}^{N} ‖ {u}_{t} - {T}_{t}^{u} ‖ {w}_{u} ,$$

where ∥.∥w represents the square of the W-norm and is defined as

$$‖ v ‖ w = {v}^{T} Wv = {\sum }_{i}^{} {W}_{ii} {v}_{i}^{2}$$

The diagonals of the weighting matrices represent the relative weights of the various objectives. We usually have only one or two primary objectives, while the rest are secondary. While the weights on the secondary objective are set to a small number, they are always nonzero and sufficiently large so that the Hessian of the problem is not very poorly conditioned. We generally try to keep the condition number below 10⁷ for double precision computation. This is also necessary to ensure that there is a unique solution for the optimal controls even in the absence of constraints. If not, imagine the case where the system could be in steady state, but yet the optimal controls could be jumping around, causing what engineers call ‘chattering’.

The reason for re-casting the problem formulation is to justify solving a convex quadratic program.

The outputs yₜ are eliminated from the problem by substituting them out using (2).

Constraints Bound constraints are typically imposed on ξ, χ, u, as well as on their rates of change. In addition, there are other linear inequality constraints involving combinations of these variables. The inequality constraints can thus be expressed as

$$AU \leq b$$

$$where$$

$$U = ( \begin{matrix}{u}_{1} \\ {x}_{2} \\ {u}_{2} \\ ⋮ \\ {x}_{N} \\ {u}_{N}\end{matrix} )$$

represents the vector of optimization variables. Note that x₁ is not an optimization variable since the initial state and control variables from the prior time determine the states x₁ at the first time point.

The Quadratic Program

We can represent the above as a strictly convex Quadratic Program (QP) in the following form

$${min}_{x} \frac{1}{2} {x}^{T} Qx + {c}^{T} x \\ s . t . Ex = b \\ Hx \leq d \qquad ( 3 )$$

Interior Point Formulation

We are going to discuss two variants of the interior point method that are suitable for this approach, even though this invention applies to any use of any interior point method to controlling gas turbine engines.

The optimality or Karush Kuhn-Tucker conditions for problem (3), assuming constraint qualifications are satisfied are as follows:

There exist vectors x, y, z such that
Qx+E^{T}y+H^{T}z=−c
Ex=b
zᵢ(dᵢ−aᵢx)=0, for all i=1, 2, . . . , p
Hx≦d
z≧0.

Alternately, slack variables s can be introduced in the inequality constraints, to convert them to Hx+s−d−0, s≧0, and the above KKT conditions can be express as
Qx+E^{T}y+H^{T}z+c=0
Ex−b=0
Hx+s−d=0
SZe=0
s,z≧0 (4)

where S=diag(s), Z=diag(z), and e=(1, 1, . . . , 1)^{T}εR^{p}. Since Q is positive semidefinite, the KKT conditions are necessary and sufficient for optimality. The first four equations above can be written as
F(x,y,z,s)=0 (5)
where F:R^{n+m+2t}→R^{n+m+2t} is the nonlinear mapping given by

$$F ( x , y , z , s ) = ( \begin{matrix}Qx + {E}^{T} y + {H}^{T} z + c \\ Ex - b \\ Hx + s - d \\ SZe\end{matrix} )$$

The Jacobian of F is

$$M ≡ {F}^{′} ( x , y , z , s ) = ( \begin{matrix}Q & {E}^{T} & {H}^{T} & 0 \\ E & 0 & 0 & 0 \\ H & 0 & 0 & I \\ 0 & 0 & S & Z\end{matrix} )$$

The central trajectory of the QP problem is the arc of points (x, y, z, s) parameterized by a positive scalar μ. Each point on the central trajectory satisfies the perturbed KKT system for some μ>0:
Qx+E^{T}y+H^{T}z+c=0
Ex−b=0
Hx+s−d=0
SZc=μe
s,z≧0 (6)

All (feasible or infeasible) interior-point algorithms generate iterates (x^{k}, y^{k}, z^{k}, s^{k}) in the neighborhood of this central path. It is this path that leads the iterates towards an optimal solution. The normalized primal dual gap μ=s^{T}z/p is a good measure of the optimality of the point (x, y, z, s) while the norms of the residuals
r_{d}=Qx+E^{T}y+H^{T}z+c,rₚ=Ex−b,and
r_{g}=s+Hx−d (7)

are natural measures of infeasibility. We use a variant of Mehrotra's predictor-corrector algorithm to solve the QP problem. His key trick is to use an estimate of the error involving the affine scaling direction. The knowledge of this error allows us to better adjust the search direction so that the duality gap is quickly reduced. We will describe the Mehrotra's predictor-corrector algorithm in the remaining part of this section. For simplicity, the index k is omitted. For a given point (x, y, z, s) with z,s>0, Mehrotra's method first computes the so called affine scaling direction d^{a}=(dₓ^{a}, d_{y}^{a}, d_{z}^{a}, dₛ^{a}), as the solution of the linear system
Md^{a}=r (8)

where r=−F(x, y, z, s)=−(r_{d}, rₚ, r_{g}, SZe). After computing the affine scaling direction, we compute the maximum step length α_{aff} that can be taken along the affine-scaing direction, as follows:
α_{aff}−arg max{αε[0,1]:(z,s)+α(d_{z}^{a},dₛ^{a})≧0}. (9)

The duality gap attained from this full step to the boundary is
μ_{aff}=(z+α_{aff}d_{z}^{a})^{T}(s+α_{aff}dₛ^{a})/p.

We set
σ=(μ_{aff}/μ)³. (10)

The second part of search direction, the center-corrector direction d^{c}=(dₓ^{c}, d_{y}^{c}, d_{z}^{c}, dₛ^{c}), is the solution of the linear system
Md^{c}=\overline{r} (11)
where \overline{r}=(0, 0, 0, σμe−diag(d_{z}^{a})dₛ^{a}). The search direction is obtained by adding the predictor and centering-corrector directions, as follows
(dₓ,d_{y},d_{z}.dₛ)=d^{a}+d^{c} (12)

The maximum step size that can be taken without violating the positivity is
αₘₐₓ=arg max{αε[0,1]:(z,s)+α(d_{z},dₛ)>0} (13)
and the new point (x⁺, y⁺, z⁺, s⁺) is obtained from (x⁺, y⁺, z⁺, s⁺)=(x, y, z, s)+α(dₓ, d_{y}, d_{z}, dₛ).

Define
N_{-∞}(β,γ)={(x,z,s):sᵢzᵢ≧βμ and infeas/μ≦γ·infeas⁰/μ⁰}
infeas=max{∥Ex−b∥₂/m,∥Hx+s−d∥₂/p}

In our implementation, we choose β=0.0001 and γ=100. The actual steplength α is chosen so that
(x⁺,y⁺,z⁺,s⁺)εN_{-∞}(β,γ) (14)

is satisfied. The condition (14) prevents the iterates from converging to the boundary prematurely. Furthermore, if all the iterates satisfy the condition (14), then they converge towards a maximal complementary solution. In this implementation, we choose the step size as follows. If the step size
step=min{0.995αₘₐₓ,1.0} (15)
satisfies (14), then it is accepted. Otherwise, the step size is reduced by
step←0.95step (16)
until the condition (14) is satisfied. Our infeasible interior-point algorithm does not require the initial point to be feasible. We choose
x⁰=0εRⁿ,y⁰=0εR^{m},z⁰=n²eεR^{P}, and s⁰=n²eεR^{p} (17)
Obviously, (x⁰, y⁰, z⁰, s⁰)εN_{-∞}(β, γ). The Mehrotra's infeasible predictor corrector algorithm can be summarized as follows.
The Infeasible Interior Point Algorithm

A1 Choose initial point (x⁰, y⁰, z⁰, s⁰) as indicated in (17).

A2 For k=0, 1, 2, . . . , set (x, y, z, s)=(x^{k}, y^{k}, z^{k}, s^{k}) and do
A 2.1 Solve (8) for d^{a}.
A 2.2 Set centering parameter to a as in (10) and solve (11) for d^{c}.
A2.3 Find a proper step size: step, based on (13), (15), and (16).
A2.4 Update the iterate (x^{k+1}, y^{k+1}, z^{k+1}, s^{k+1})=(x^{k}, y^{k}, z^{k}, s^{k})+step*(dₓ, d_{y}, d_{z}, dₛ)

The infeasible interior-point algorithm as defined above is not quite the same as Mehrotra's original algorithm. For example, the choices of starting point and stepsize are different. This algorithm is referred to as Mehrotra predictor-corrector algorithm due to the fact that his choice of the centering parameter (10) has proved to be effective in exhaustive computational testing.

Termination tolerances on the iterative procedure that are effective for our problem (i.e., satisfy real-time requirements and produce a good solution), are
μ≦10⁻⁵ and infeas≦10⁻⁶ (18)

Two systems are solved at each step of the algorithm and both systems use the same coefficient matrix. Therefore, only one matrix factorization is needed in case a direct method is used for solving (8) and (11). Moreover, these two systems can be further reduced to smaller systems. To this end, consider

$$( \begin{matrix}Q & {E}^{T} & {H}^{T} & 0 \\ E & 0 & 0 & 0 \\ H & 0 & 0 & I \\ 0 & 0 & S & Z\end{matrix} ) ( \begin{matrix}{d}_{x} \\ {d}_{y} \\ {d}_{z} \\ {d}_{s}\end{matrix} ) = ( \begin{matrix}{r}_{1} \\ {r}_{2} \\ {r}_{3} \\ {r}_{4}\end{matrix} ) , \qquad ( 19 )$$

where in the predictor step
r₁=−r_{d},r₂=−rₚ,r₃=−r_{g},r₄=−SZe
while in the corrector step
r₁=0,r₂=0,r₃=0,r₄=σμe−diag(d_{z}^{a})dₛ^{a}.

From the third equation of (19), we have
dₛ=−Hdₓ+r₃, (20)
which, together with the fourth equation of (19), implies
d_{z}=S⁻¹(r₄−Zdₛ)=S⁻¹AHdₓ+S⁻¹(r₄−Zr₃). (21)
Substituting (21) into the first equation of (19), together with the second equation of (19), we have a smaller system for (dₓ, d_{y})

$$( \begin{matrix}Q + {H}^{T} {S}^{- 1} ZH & {E}^{T} \\ E & 0\end{matrix} ) ( \begin{matrix}{d}_{x} \\ {d}_{y}\end{matrix} ) = ( \begin{matrix}{r}_{1} + {H}^{T} {S}^{- 1} ( {Zr}_{3} - {r}_{4} ) \\ {r}_{2}\end{matrix} ) \qquad ( 22 )$$

Thus the large system (19) can be solved by first, solving the smaller system (22) for dₓ and d_{y} and then using (20) and (21) to find the values for dₛ and d_{z}. We can go a step further and by substituting dₓ, from the first equation of (22) into the second equation, we have
E(Q+H^{T}S⁻¹ZH)⁻¹E^{T}d_{y}=−r₂+E(Q+H^{T}S⁻¹ZH)⁻¹(r₁+H^{T}S⁻¹(Zr₃−r₄)) (23)

Then the dₓ can be obtained by
dₓ=(Q+H^{T}S⁻¹ZH)⁻¹E^{T}d_{y}(Q+H^{T}S⁻¹ZH)⁻¹(r₁+H^{T}S⁻¹(Zr₃−r₄)). (24)

The system (23) can be solved by an iterative method (for example, conjugate gradients) or a direct method (for example, sparse Cholesky). The main problems with this approach are that the system (23) can be much more ill conditioned than the system (22) and the coefficient matrix of (23) can be much denser than the argumented system (22). Both methods are implemented using direct methods and observed that the numbers of iterations required for convergence for both cases are similar. Finally, as we approach a solution, many of the components of S⁻¹Z=diag(z₁/s₁, z₂/s₂, . . . , zₜ/sₜ) will tend to zero so that the scaling of the matrix S⁻¹Z can become very bad, although the work of Stewart, Vavasis, and Wright shows that the overall system is not nearly as ill-conditioned. For the accuracy required in our application, the iterates satisfied convergence tolerance before any serious ill-conditioning appeared in the computation.

An Infeasible Interior-Point Homogeneous Algorithm

This is the second of the two methods that applies to our problem of controlling gas turbine engines. A special case when H=−I and d=0 of our method described below is implemented in the commercial package MOSEK by Erling Andersen.

First, a homogeneous formulation of the QP problem is developed. It is easily seen that the KKT system (4) of the QP problem is not homogeneous. In order to find a homogeneous formulation, a nonnegative scalar r is introduced and the variables x, y, z, and s are re-scaled. The first three equations of (4) become
Qx+E^{T}y+H^{T}z+τc=0
Ex−τb=0
Hx+s−τd=0 (25)

It is easily seen from (25) that

$$\begin{matrix}{z}^{T} s = - {z}^{T} Hx + τ {z}^{T} d \\ = {x}^{T} ( - H z ) = + τ {z}^{T} d \\ = {x}^{T} Qx + {x}^{T} {E}^{T} y + τ {x}^{T} c + τ {z}^{T} d \\ = {x}^{T} Qx + τ {b}^{T} y + τ {c}^{T} x + τ {z}^{T} d\end{matrix}$$

$$Define$$

$$\begin{matrix}κ = - \frac{1}{τ} {z}^{T} s = - \frac{1}{τ} ( {x}^{T} Qx + τ {b}^{T} y + τ {c}^{T} x + τ {z}^{T} d ) \\ = - {x}^{T} Q ξ - {b}^{T} y - {c}^{T} x - {z}^{T} d \\ = - {x}^{T} g - {b}^{T} y - {z}^{T} d\end{matrix}$$

where ξ=x/τ, g=c+Qξ. Obviously, if (x, y, z, s) is a solution to (4), then κ=0.

Thus, (x, y, z, s) together with τ=1, κ=0, will be a solution to the following system
Qx+E^{T}y+H^{T}z+τc=0
g^{T}x+b^{T}y+d^{T}z+κ=0
Ex−τb=0
Hx+s−τd=0
SZe=0
τκ=0
Z,S,τ,κ≧0 (26)

Moreover, following the proofs of Andersen and Ye [1], the following results are established: Let (x*, y*, z*, s*, τ*, κ*) be a maximal complementary solution to (26). Then

1. The QP has a solution if and if τ*>0. In this case (x*/τ*, y*/τ*, z*/τ*, s*/τ*) is a solution to the QP.

2. The QP is infeasible if and only if κ*>0.

Equation (26) is equivalent to the following mixed linear complementarity problem:
z^{T}s+τκ=0
subject to Qx+E^{T}y+H^{T}z+τc=0
g^{T}x+b^{T}y+d^{T}z+κ=0
Ex−τb=0
Hx+s−τd=0
z,s,τ,κ≧0 (27)

The problem (27) is homogeneous, since the right-hand sides of all the constraints are zero. Homogeneity makes for a conical feasible region: If (x, y, z, s, τ, κ) is feasible for (27), the entire ray α(x, y, z, s, τ, κ), α≧0, is also feasible. The complementarity condition z^{T}s+τκ=0 is always true in this case. In fact, it is a direct consequence of the definition of κ. Therefore, there is no strict feasible point for (27). Consequently, the (pure) interior-point algorithms which require an initial strict interior-point can not be employed for its solution. So an infeasible-interior-point method is used to solve the problem. In this implementation, the one described in the previous section is chosen. The advantage of this approach is that we either find a solution of the original QP problem or we produce a “certificate” that the original problem is infeasible.

The Jacobian of the system formed by the first six equations of (26) is

$${M}_{h} = ( \begin{matrix}Q & c & {E}^{T} & {H}^{T} & 0 & 0 \\ ( {g}^{T} + {ξ}^{T} Q ) & - {ξ}^{T} Q ξ & {b}^{T} & {d}^{T} & 0 & 1 \\ E & - b & 0 & 0 & 0 & 0 \\ H & - d & 0 & 0 & T & 0 \\ 0 & κ & 0 & 0 & 0 & τ \\ 0 & 0 & 0 & S & Z & 0\end{matrix} )$$

Define
r_{d}=Qx+E^{T}y+H^{T}z+τc,r_{g}=x^{T}g+b^{T}y+d^{T}z+κ,rₚ=Ex−τb, rᵢ=Hx+s−τd (28)

Similar to (8), the affine scaling direction dₕ^{a}=(dₓ^{a}, d_{τ}^{a}, d_{y}^{a}, d_{z}^{a}, dₛ^{a}, d_{κ}^{a}) in this case is the solution of the following system:
Mₕdₕ^{a}=τₕ (29)
where rₕ=−(r_{d}, r_{g}, rₚ, rᵢ, τκ, SZe). After computing the affine scaling direction, the maximum step length α_{a∫∫} that can be taken along the affine-scaling direction is computed as follows:
α_{ff}=arg max{αε[0,1]: (z,s,τ,κ)+α(d_{z}^{a},dₛ^{a},d_{τ}^{a},d_{κ}^{a})≧0} (30)

The duality gap attained from this full step to the boundary is
μ_{aff}((z+α_{aff}d_{z}^{a})^{T}(s+α_{aff}dₛ^{a})+(τ+α_{aff}d_{τ}^{a})(κ+α_{aff}d_{κ}^{a}))/(t+1).
We set
σ(μ_{aff}/μ)³ (31)
where μ=(z^{T}s+τκ)/(t+1). The second part of search direction, the center-corrector direction dₕ^{c}=(dₓ^{c}, d_{τ}^{c}, d_{y}^{c}, d_{z}^{c}, dₛ^{c}, d_{κ}^{c}), is the solution of the linear system
Mₕdₕ^{c}=\overline{r} (32)
where \overline{r}=(0, 0, 0, 0, σμ−diag(d_{τ}^{a})d_{κ}^{a}, σμe−diag(d_{z}^{a})dₛ^{a}). The search direction is obtained by adding the predictor and centering-corrector directions, as follows
(dₓ,d_{τ},d_{y},d_{z},dₛ,dκ)=dₕ^{a}+dₕ^{c} (33)

The maximum step size that can be taken without violating the positivity is
αₘₐₓ=arg max{αε[0,1]:(z,s,τ,κ)+α(d_{z},dₛ,d_{τ},d_{κ})≧0} (34)
and the new point (x⁺, τ⁺, y⁺, z⁺, s⁺, κ⁺) is obtained from (x⁺, τ⁺, y⁺, z⁺, s⁺, κ⁺)=(x, τ, y, z, s, κ)+α(dₓ, d_{τ}, d_{y}, d_{z}, dₛ, dκ)

In the homogeneous case, the neighborhood of the central trajectory is defined as
N_{-∞}(β,γ)={(X,τ, y,z,s,κ):sᵢzᵢ≧βμ, τκ≧βμ, and infeas/μ≦γ·infeas⁰/μ⁰}
infeas=max{∥Ex−τb∥₂/m, ∥Hx+s−τd∥₂/p}

In our implementation, we also choose β=0.0001 and γ=100. The actual steplength α is chosen so that
(x⁺,τ⁺,y⁺,z⁺,s⁺,κ⁺)εN_{-∞}(β,γ) (35)
is satisfied. The condition (35) prevents the iterates from converging to the boundary prematurely. Furthermore, if all the iterates satisfy the condition (35), then they converge towards a maximal complementary solution. In this implementation, we choose the step size as follows. If the step size
step−min{0.995αₘₐₓ,1.0} (36)
satisfies (35), then it is accepted. Otherwise, the step size is reduced by
step←0.95step (37)
until the condition (35) is satisfied. Our infeasible interior-point homogeneous algorithm starts with the following initial point.
x⁰=0εRⁿ,τ⁰=1,y⁰=0εR^{m},z⁰=eεR^{p},s⁰=eεR^{p}, and κ⁰=1 (38)
Obviously, (x⁰, τ⁰, y⁰, z⁰; s⁰, κ⁰)εN_{-∞}(β,γ). Next, we summarize the infeasible predictor corrector homogeneous algorithm as follows.
An Infeasible Interior-Point Homogeneous Algorithm

A1 Choose initial point (x⁰, τ⁰, y⁰, z⁰, s⁰, κ⁰) as indicated in (38).

A 2 For k=0, 1, 2, . . . , set (x, τ, y, Z, s, κ)=(x^{k}, τ^{k}, y^{k}, z^{k}, s^{k}, κ^{k}) and do
A 2.1 Solve (29) for dₕ^{a}.
A 2.2 Set centering parameter to a as in (31) and solve (32) for dₕ^{c}.
A 2.3 Find a proper step size: step, based on (34), (36), and (37).
A 2.4 Update the iterate
   (x^{k+1},τ^{k+1},y^{k+1},z^{k+1},s^{k+1},κ^{k+1})=(x^{k},τ^{k},y^{k},z^{k},s^{k}, κ^{k})+step*(dₓ,d_{τ},d_{y},d_{z},dₛ,d_{κ})

Once again, the systems (29) and (32) can be further reduced to smaller systems. To this end, we consider

$$( \begin{matrix}Q & c & {E}^{T} & {H}^{T} & 0 & 0 \\ ( {g}^{T} + {ξ}^{T} Q ) & - {ξ}^{T} Q ξ & {b}^{T} & {d}^{T} & 0 & 1 \\ E & - b & 0 & 0 & 0 & 0 \\ H & - d & 0 & 0 & I & 0 \\ 0 & κ & 0 & 0 & 0 & τ \\ 0 & 0 & 0 & S & Z & 0\end{matrix} ) ( \begin{matrix}{d}_{x} \\ {d}_{τ} \\ {d}_{y} \\ {d}_{z} \\ {d}_{s} \\ {d}_{κ}\end{matrix} ) = ( \begin{matrix}{a}_{1} \\ {a}_{2} \\ {a}_{3} \\ {a}_{4} \\ {a}_{5} \\ {a}_{6}\end{matrix} ) , \qquad ( 39 )$$

where in the predictor step
a₁=−r_{d},a₂=−r_{g},a₃=−rₚ,a₄=−rᵢ, a₅=−τκ,and a₆=−SZe
while in the corrector step
a₁=0,a₂=0,a₃=0,a₄=0,a₅=σμ−diag(d_{τ}^{a})d_{κ}^{a},a₆=σμe−diag(d_{z}^{a})dₛ^{a}.

It can be shown that the linear system (39) can be solved through a smaller system. First solve dₓ, d_{τ}, and d_{y} from the system

$$( \begin{matrix}Q + {H}^{T} {S}^{- 1} ZH & c - {H}^{T} {S}^{- 1} Zd & {E}^{T} \\ ( {g}^{T} + {ξ }^{T} Q + {d}^{T} {S}^{- 1} ZH ) & - ( {ξ}^{T} Q ξ + {d}^{T} {S}^{- 1} Zd + {τ}^{- 1} κ ) & {b}^{T} \\ E & b & 0\end{matrix} ) ( \begin{matrix}{d}_{x} \\ {d}_{τ} \\ {d}_{y}\end{matrix} ) = \hat{r} , \\ where \\ \hat{r} = ( \begin{matrix}{a}_{1} + {H}^{T} {S}^{- 1} {Za}_{4} - {H}^{T} {S}^{- 1} {a}_{6} \\ {a}_{2} + {d}^{T} {S}^{- 1} {Za}_{4} - {d}^{T} {S}^{- 1} {a}_{6} - {τ}^{- 1} {a}_{5} \\ {a}_{3}\end{matrix} ) . \qquad ( 40 )$$

Then dₛ, d_{z}, and d_{κ} can be computed from
dₛ=−Hdₓ+dᵣd+a₄
d_{z}=−S⁻¹Zdₛ+S⁻¹a₆
d_{κ}=−τ⁻¹κdᵣ+τ⁻¹a₅

In our implementation, we use the reduced system to get both predictor and corrector directions.

Finally, the homogeneous algorithm described in this section is a novel extension of Andersen and Ye's homogeneous algorithm [1] which is only suitable for QP in standard form when H=−I and d=0. The simplified homogeneous and self-dual linear programming algorithm by Xu, Hung, and Ye [4] is only suitable for linear programming when Q=0, H=−I, and d=0. Of course, these algorithms are closely related.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers for steps in the method claims are for ease of reference by dependent claims, and do not indicate a required sequence, unless otherwise indicated.

1. A method for formulating and optimizing a quadratic programming problem including the steps of:
a) in each of a plurality of timesteps, formulating a problem of controlling a gas turbine engine to achieve a desired dynamic response as a solution to a quadratic programming problem; and
b) solving the quadratic programming problem in real time in each time step using an interior point algorithm which searches for an optimal solution.

2. The method of claim 1 wherein said step a) further includes the step of formulating the problem of controlling the gas turbine engine to achieve a desired dynamic response for a multiple timestep window as the solution to the quadratic programming problem.

3. The method of claim 2 further including the step of:
c) using a predictor-corrector algorithm to solve the quadratic programming problem in the format of:
$${min}_{x} \frac{1}{2} {x}^{T} Qx + {c}^{T} x \\ s . t . Ex = b \\ Hx \leq d \qquad ( 3 )$$

4. The method of claim 3 wherein said step c) further includes the steps of iteratively:
d) computing an affine scaling direction;
e) computing a center-correction direction;
f) obtaining a search direction based upon the affine scaling direction and the center-correction direction;
g) determining a maximum step size; and
h) updating an iterate based upon a previous iterate, the maximum step size and the search direction.

5. The method of claim 1 wherein said step b) further includes the step of using an infeasible interior-point method.

6. A model predictive control system comprising:
a desired trajectory generator for creating a desired trajectory;
a linearization module deriving a linearized model about the desired trajectory;
a quadratic programming module in each of a plurality of time steps formulating a problem of achieving the desired trajectory for a multiple timestep window as a solution to a quadratic programming problem;
a quadratic programming solver for solving an optimization problem established by the quadratic programming module to generate a profile of optimal controls, the quadratic programming solver solving the quadratic programming problem in real time in each time step using an interior point algorithm which searches for an optimal solution.

7. The model predictive control system of claim 6 wherein the quadratic programming solver generates control signals for controlling a gas turbine engine.

8. The model predictive control system of claim 6 wherein the quadratic programming solver solves the quadratic programming problem using an iterative algorithm.

9. The model predictive control system of claim 8 wherein the quadratic programming solver iteratively optimizes a solution to the quadratic programming problem using the interior point algorithm.

10. The model predictive control system of claim 9 wherein the quadratic programming solver generates control signals for controlling a gas turbine engine.

11. The model predictive control system of claim 10 wherein the quadratic programming problem solver uses a predictor-corrector algorithm to solve the quadratic programming problem.

12. The model predictive control system of claim 11 wherein the quadratic programming problem solver uses an infeasible interior point algorithm to solve the quadratic programming problem.

13. The model predictive control system of claim 12 wherein the quadratic programming problem solver computes an affine scaling direction, computes a center-correction direction, obtains a search direction based upon the affine scaling direction and the center-correction direction, determines a maximum step size, and updates an iterate based upon a previous iterate, the maximum step size and the search direction.

14. The model predictive control system of claim 12 wherein the infeasible interior point algorithm uses the following initial point:
x⁰=0εRⁿ,τ⁰=1,y⁰=0εR^{m},z⁰=eεR^{p},s⁰=eεR^{p}, and κ⁰=1 (38)
